(19) United States
(12) Patent Application Publication
(10) Pub. No.: US 2025/0008913 A1
(43) Pub. Date: Jan. 9, 2025

(54) COMBINATION RABBIT FEEDER AND LITTER

(71) Applicants: WADE BALLANCE, LOS ANGELES, CA (US); LORELEI CARLSON, LOS ANGELES, CA (US)

(72) Inventors: WADE BALLANCE, LOS ANGELES, CA (US); LORELEI CARLSON, LOS ANGELES, CA (US)

(21) Appl. No.: 17/984,369

(22) Filed: Nov. 10, 2022

(51) Int. Cl. A01K 1/01; A01K 5/01

(52) U.S. Cl. CPC A01K 1/0107; A01K 5/0114

(57) ABSTRACT

The enclosed invention is a unitary, combination rabbit feeder and litter. More specifically, provided is a functional, portable rabbit feeder and litter that provides both a chute for food storage (e.g., hay) and an enclosed area in which a rabbit or rabbits may expunge.

### FIELD OF THE INVENTION

The enclosed invention is a unitary combination rabbit feeder and litter (i.e., feeder/litter). More specifically, provided is a functional, portable rabbit feeder and litter that provides both a chute for food storage (e.g., hay) and an enclosed area in which a rabbit or rabbits may expunge.

### BACKGROUND OF THE INVENTION

Pet care in America is a multi-billion dollar venture. Such pets are a daily feature of our lives and are the recipients of every kind of human attention to their healthcare needs, diets, housing and waste management.

Pet rabbits, in particular, have long been included in households as loving members of many families. Their care is paramount, and not insignificant. Rabbits require a steady, easily reached food source and also a ready place to expel that is familiar, conducive to such and easily maintained by their human owners.

Providing a feeder in which a rabbit can both feed and expel is ideal, but up to now, has been difficult to achieve. Prior art attempts at this have provided an open litter with a separate, unattached feeding means (e.g., one or more bowls). Treating the two components as unitary without the actual qualities thereof is difficult. For example, moving an unattached or non-unitary, uncoupled feeder and litter is more difficult, potentially messy and unstainable in the long term. It also makes travel with a pet undesirable.

What is therefore needed is an invention that enables a rabbit feeder and litter as a unitary device for ease of use, cleaning and moving. Ideally, the rabbit feeder and litter should be readily movable and travel worthy if desired by a pet owner. Embodiments satisfying these requirements are provided with detail and explanation herein.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Accordingly, the invention herein provides a combination rabbit feeder and litter (i.e., “feeder/litter”) of unitary construction, comprising a housing that has an open end with a portal and a closed end juxtaposed to the open end. The feeder/litter comprises a base and a ceiling positioned oppositely to the base. The ceiling has an opening positioned juxtaposed to the closed end of the housing.

The housing further comprises a left wall connected between the open end and the closed end. A right wall is positioned oppositely from the left wall, the right wall being connected to the open end and the closed end. A chute is connected to the closed end of the rabbit feeder/litter. The chute has a holding portion into which rabbit feed (e.g., hay) may be stored for consumption by rabbit entering with the combination rabbit feeder and litter.

Typically, the rabbit feeder/litter comprises one type of material. A suitable material for such use is polyurethane (i.e., hard plastic). Persons of skill in the art will be well familiar with this and similar materials useful in the construction of the rabbit feeder/litter. The rabbit feeder/litter may comprise more than one type of material that includes polyurethane, or is wood, metal, a composite material, a naturally occurring material or man-made material. Persons of skill in the art are free to fashion the enclosed, described feeder/litter from whatever determined suitable material.

The combination rabbit feeder and litter may comprise an absorbent material positioned onto the base for a rabbit's use. The absorbent material is removable once saturated and/or at the discretion of the users of the rabbit feeder/litter.

The combination rabbit feeder and litter is intended to be portable and may comprise a handle positioned onto the top (i.e., the ceiling) of the feeder/litter. Alternatively, the rabbit feeder and litter may be detachable into two parts, a top and a bottom.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 provides a perspective view of the feeder/litter herein;

FIG. 2 provides a perspective view of the feeder/litter of FIG. 1 showing the feeder placed within the feeder/litter;

FIG. 3 provides a perspective view of the feeder/litter of FIG. 1 with the feeder removed from the feeder/litter; and

FIG. 4 is an exploded view of the feeder/litter of FIG. 1 showing the top portion of the feeder/litter removed from its base.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

By the term “unitary” it is meant herein a design of the feeder/litter herein which is made from a one-piece design typically from an extrusion process.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all devices, methods and systems. This applies to all aspects of this application including, but not limited to, steps in disclosed methods and parts of disclosed devices.

Thus, if there are a variety of additional steps that can be performed it is understood that each of these additional steps can be performed with any specific aspect or combination of aspects of the disclosed methods.

The invention herein provides a combination rabbit feeder and litter (i.e., “feeder/litter”) of preferably unitary construction, comprising a housing that has an open end with a portal and a closed end juxtaposed to the open end. The feeder/litter comprises a base and a ceiling positioned oppositely to the base. The ceiling has an opening positioned juxtaposed to the closed end of the housing.

The housing further comprises a left wall connected between the open end and the closed end. A right wall is positioned oppositely from the left wall, the right wall being connected to the open end and the closed end. A chute is connected to the closed end of the rabbit feeder/litter. The chute has a holding portion into which rabbit feed (e.g., hay) may be stored for consumption by rabbit entering with the combination rabbit feeder and litter.

Typically, the rabbit feeder/litter comprises one type of material. A suitable material for such use is polyurethane (i.e., hard plastic). Persons of skill in the art will be well familiar with this and similar materials useful in the construction of the rabbit feeder/litter. Alternatively, the rabbit feeder/litter may comprise more than one type of material that includes polyurethane, or is wood, metal, a composite material, a naturally occurring material or man-made material. Persons of skill in the art are free to fashion the enclosed, described feeder/litter from suitable material determined by persons of skill in the art.

The combination rabbit feeder and litter may comprise an absorbent material positioned onto the base for a rabbit's use. The absorbent material is removable once saturated and/or at the discretion of the users of the rabbit feeder/litter.

The combination rabbit feeder and litter is intended to be portable and may comprise a handle positioned onto the ceiling of the feeder/litter. Alternatively, the rabbit feeder and litter may be detachable into two parts, a top and a bottom.

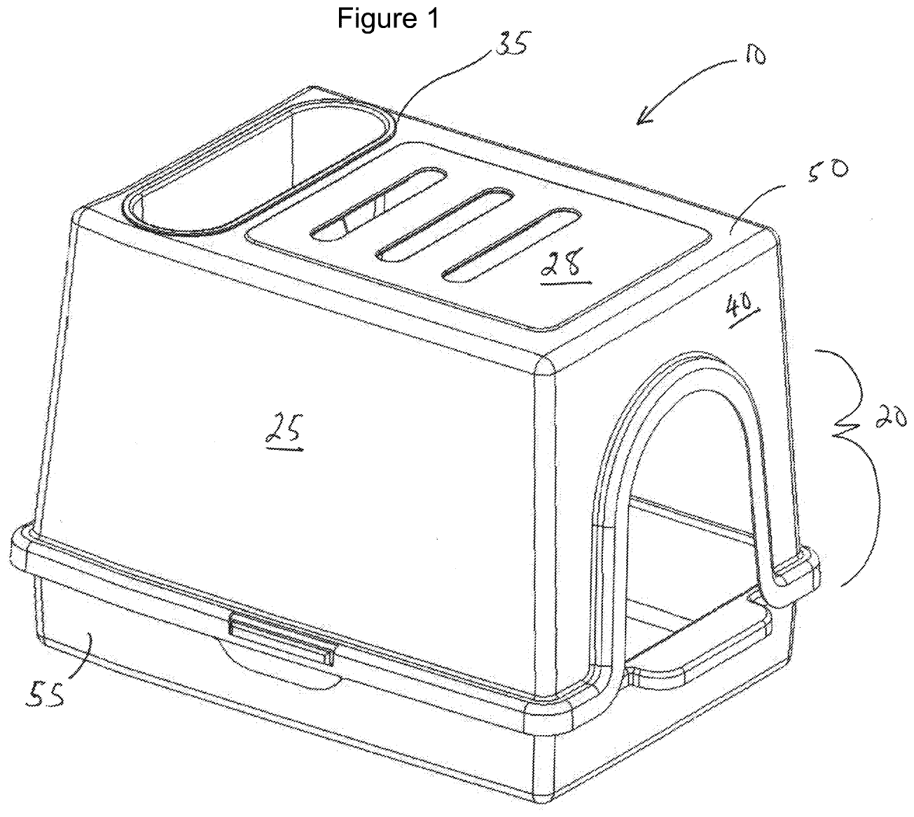

FIG. 1 provides a perspective view of the feeder/litter 10 herein. It has a front side wall 40 at one end with portal 20 which allows a rabbit to enter and exit. Feeder/litter 10 also comprises two side walls 25 positioned opposite to one-another and a back end 45 (not shown). A feed device 30 (or “feed”) is positioned adjacent to back end 45. Feed 30 has a feed opening 35 into which feed 30 is placed. Preferred food or feed intended for use in feeder/litter 10 is hay. Feed device 30 comprises a volume and an opening at its end that allows a rabbit access to hay or other feed type placed therein.

Feeder/litter 10 preferably comprises suitable materials of one or more types of plastics and/or composite materials. For example, feeder/litter 10 may comprise polyethylene (PE), polypropylene (PP), polycarbonate (PC), and acetal polyoxymethylene (POM) and the like.

There are a number of different variants of polyethylene. Low and high density polyethylene (LDPE and HDPE respectively) are the two most common and the material properties vary across the different variants. LDPE is the plastic used for plastic bags in grocery stores. It has high ductility but low tensile strength. HDPE is a stiff plastic used for more robust plastic packaging like laundry detergent containers as well as for construction applications or trash bins and is preferred for use in feeder/litter 10 herein. Alternatively, UHMW is an extremely strong plastic that can rival or even exceed steel in strength and is used is for applications like medical devices (e.g. artificial hips).

Polypropylene is used in a variety of applications to include packaging for consumer products, plastic parts for the automotive industry, special devices like living hinges, and textiles. It is semi-transparent, has a low-friction surface, doesn't react well with liquids, is easily repaired from damage and has good electrical resistance (i.e., it is a good electrical insulator). Perhaps most importantly, polypropylene is adaptable to a variety of manufacturing techniques which makes it one of the most commonly produced and highly demanded plastics on the market.

Polycarbonate is a high strength transparent material known for its particularly high impact strength relative to other plastics. It is used in greenhouses where high transmissivity and high strength are both required or in riot gear for police.

Acetal is a very high tensile strength plastic with significant creep resistant properties that bridge the material properties gap between most plastics and metals. It is known for high resistance to heat, abrasion, water, and chemical compounds. Additionally, Acetal has a particularly low coefficient of friction which combined with its other characteristics makes it very useful for applications that utilize gears.

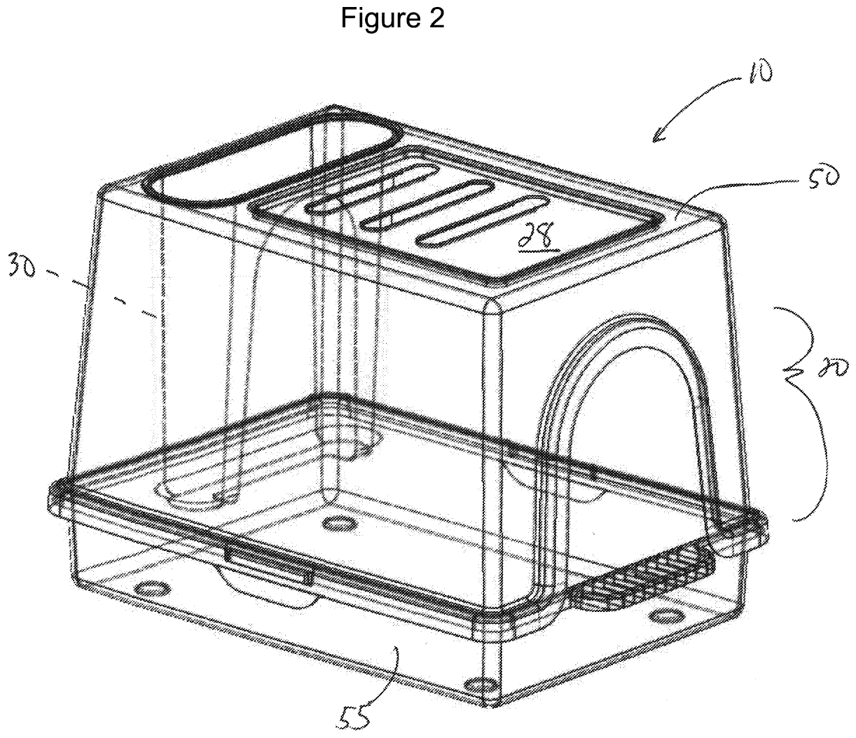

FIG. 2 provides a perspective view of the feeder/litter 10 of FIG. 1 showing feeder 30 placed within feeder/litter 10. As shown, feeder 30 is in outline and sits to the rear of feeder/litter 10. It extends from ceiling 50 near to its base 55. Portal 20 is featured prominently at the front of feeder/litter 10.

Removable panel 28 is an independent piece that sits upon ceiling 50 and is removable from feeder/litter 10. Because of its removability, a pet owner can readily clean feeder/litter 10 from both pet waste and discarded feed.

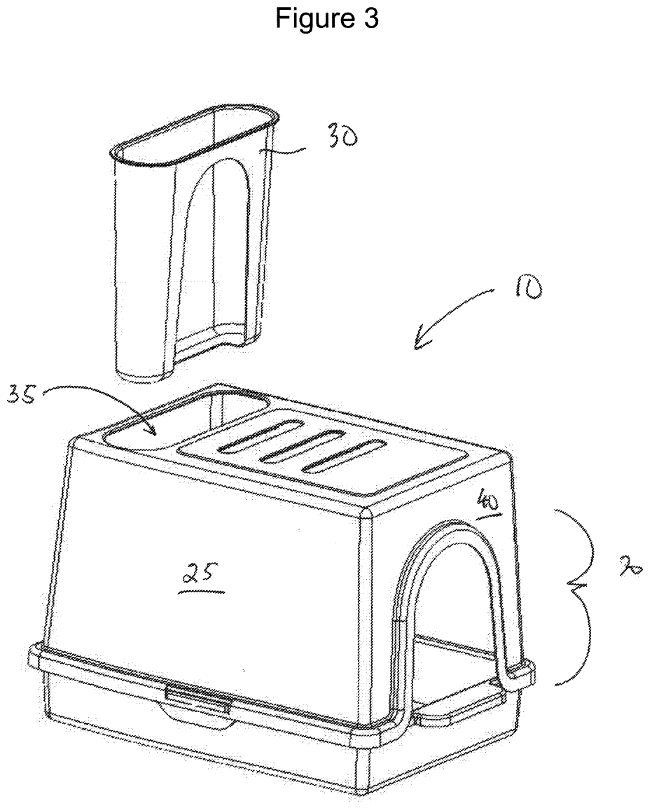

FIG. 3 provides a perspective view of feeder/litter 10 of FIG. 1 with feed 30 removed from feeder/litter 10. As is shown, feed 30 is configured to fit within feed portal 35 and hang upon its lip (i.e., a portion of ceiling 50) when placed within feed portal 35. In practice, a pet owner can easily remove feed 30 and place feed therein for consumption by one or more rabbits. Feed 30 is also readily removable for cleaning by a pet owner. When it is placed within feeder/litter 10 the bottom thereof sits slightly above base 55 allowing for a gap or area of clearance between the floor of base 55 and the bottom of feed 30.

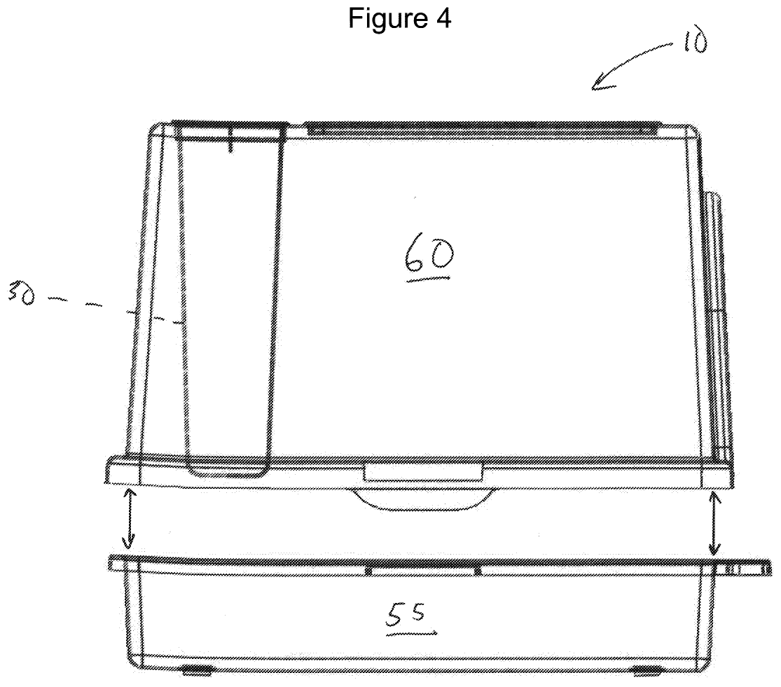

FIG. 4 is an exploded view of feeder/litter 30 of FIG. 1 showing top portion 60 of feeder/litter 10 removed from base 55. In this alternative embodiment, feeder/litter 10 comprises two portions feed housing 60 and feed base 55. To more thoroughly clean feeder/litter 10, a pet owner can detach feed housing 60 from feed base 55.

Attachment means between feed housing 60 and base 55 can be by snap-and-fit, latches, buttons and more. Persons of skill in the art will readily recognize that there a number of well-known ways by which to attach two or more components (e.g., feed housing 60 and base 55) to one-another, the selection of which forms no part of the invention herein.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A combination rabbit feeder and litter of unitary construction, comprising:
a. A housing, said housing having an open end with a portal and a closed end juxtaposed to said open end;
b. A base;
c. A ceiling positioned oppositely to said base, said ceiling having an opening positioned juxtaposed to said closed end of said housing;
d. A left wall connected between said open end and said closed end;
e. A right wall positioned oppositely from said left wall, said right wall being connected to said open end and said closed end;
f. A chute connected to (positioned about) the closed end of said rabbit feeder and litter, said chute having a holding portion into which rabbit feed may be stored for consumption by rabbit entering with said combination rabbit feeder and litter.

2. The combination rabbit feeder and litter of claim 1 wherein said rabbit feeder and litter comprises one type of material.

3. The combination rabbit feeder and litter of claim 2 wherein said rabbit feeder and litter is comprised of unitary construction.

4. The combination rabbit feeder and litter of claim 2 wherein said type of material is polyurethane (i.e., hard plastic).

5. The combination rabbit feeder and litter of claim 1 wherein said rabbit feeder and litter comprises more than one type of material.

6. The combination rabbit feeder and litter of claim 1 further comprising an absorbent material positioned onto said base.

7. The combination rabbit feeder and litter of claim 6 wherein said absorbent material is removable.

8. The combination rabbit feeder and litter of claim 1 wherein said rabbit feeder and litter is portable.

9. The combination rabbit feeder and litter of claim 1 wherein said rabbit feeder and litter is detachable into two parts.

10. The combination rabbit feeder and litter of claim 9 wherein said base is detachable from said remainder of said combination rabbit feeder and litter.
